(19) United States
(12) Patent Application Publication
(10) Pub. No.: US 2006/0107198 A1
(43) Pub. Date: May 18, 2006

(54) Electronic content publication management system and method

(76) Inventors: Brian C Solomon, Bendigo (AU); Peter Barker, Flynn (AU); Carlton Davison, Strathdale (AU); Andrew Cameron Bishop, Phillip (AU)

Correspondence Address: BROWN RAYSMAN MILLSTEIN FELDER & STEINER, LLP, 1880 CENTURY PARK EAST, 12TH FLOOR, LOS ANGELES, CA, 90067, US

(21) Appl. No.: 10/521,414

(22) PCT Filed: Jul. 11, 2003
(86) PCT No.: PCT/AU03/00900

§ 371 Date: Aug. 8, 2005

(30) Foreign Application Priority Data
Jul. 11, 2002 (AU) 2002950122

(51) Int. Cl. G06F 17/21; G06F 17/30

(52) U.S. Cl. 715/513; 715/517; 707/1; 707/9

(57) ABSTRACT

An electronic content publication management system (1) for publishing content to one or more electronically accessible sites, each site including at least one electronic page (40), the system comprising content database means (2) for storing a plurality of content objects (3); content management database means (4) for storing a data structure (5) identifying each electronic page, one or more content pools (52, 59) within each page and one or more content objects (57, 58, 63, 64) within each page, wherein the data structure identifies one or more nested content pools or content objects within each content pool; and electronic page assembly means (10, 11, 12) for generating one or more completed electronic pages for each site using the stored data structure and stored content objects.

The present invention relates to a method and system for the management of electronic content published to one or more electronically accessible sites. The invention is suitable for use by non-technical users in the design, content selection and layout of a web site including one or more electronic pages in a distributing environment, and it will be convenient to describe the invention in relation to that exemplary application.

For many administrators of web and other electronically accessible sites, the inability to control the structure of electronic pages within that site without programming skills creates an undesirable dependence on programmers. Various systems currently exist for managing content objects on electronic pages, but each uses hard coding to define where content objects appear on a page. Using hard code pages or templates to define where content objects appear creates a dependency on administrators with access to programming skills, and restricts the scope of non-technical administrators to manage page design, content and layout.

By using a hard coded electronic page or a template to define an electronic page structure and layout, the existing content management systems are limited to two levels of structure, namely a page level and a content level. Moreover, existing content management systems require a programmer to create a basic page structure. Only the content level can be delegated to a non-programmer, because control over the page level requires programming skills.

It would therefore be desirable to provide an electronic content publication management system that enabled the creation or modification of electronic page structures without requiring programming skills.

It would also be desirable to provide an electronic content publication management system that enabled electronic page design, content and/or layout, or enable the sharing of structural objects of an electronic page, without requiring programming skills.

It would also be desirable to provide an electronic content publication management system where the administration of structural objects of an electronic page can be delegated.

It would also be desirable to provide an electronic content publication management system and method that ameliorates or overcomes one or more problems of known prior art systems and methods, or at least provides a practical alternative to those systems and methods.

With this in mind, one aspect of the present invention provides an electronic content publication management system for publishing content to one or more electronically accessible sites, each site including at least one electronic page, the system comprising:

content database means for storing a plurality of content objects;

content management database means for storing a data structure identifying each electronic page, one or more content pools within each page and one or more content elements in each page, wherein the data structure identifies one or more nested content pools or content objects within each content pool; and

electronic page assembly means for generating one or more completed electronic pages for each site using the stored data structure and stored content objects.

A system including these features enables electronic pages to be created that include sub divisions to create smaller sub sections of the electronic page. By nesting tables and similar devices in different combinations, an endless variety of page structures can be created. Traditionally, programmers have been required to create page structures, but by using a system including the above referenced features, the same structure can be created without programming skills, thereby overcoming limitations of prior art systems and enabling non-technical users to create and manage page design, content and/or layout in a distributed environment.

In one or more embodiments of the invention, the data structure includes a plurality of tags, each identifying a separate electronic page, content pool or content object.

Each tag may identify the location of one or more content objects or one or more content pools.

At least one content pool tag may identify one or more other tags.

The one or more other tags may include an associated ranking of that tag within an associated content pool.

One or more tags may include display instructions for use in conjunction with the tag rankings to control the layout of content objects within the electronic page.

The electronic page means may be adapted to layout the content pools or content objects identified by the one or more other tags in a table within the electronic page according to the tag rankings.

The content management database means may store permission rights to selectively enable the modification of the data structure and/or the content objects.

The permission rights may include the right to delegate some or all of the permission rights.

The electronic page assembly means may be adapted to display at a remote terminal an administration view of the electronic page, the administration view including visually distinct representations of each content pool and content object within the electronic page.

Each visually distinct representation may include one or more control elements to enable user modification of that content pool or content object within the data structure.

Another aspect of the invention provides an electronic content publication management method for publishing content to one or more electronically accessible sites, each site including at least one electronic page, the method including the steps of:

storing a plurality of content objects in content database means;

storing a data structure identifying each electronic page, one or more content pools within each page and one or more content elements within each page in content management database means, wherein the data structure identifies one or more nested content pools or content objections within each content pool; and

generating one or more completed electronic pages for each site using the stored data structure and stored content objects.

In at least one embodiment, the method may further include the step of:

laying out the content pools or content objects identified by the one or more other tags in a table within the electronic page according to the tag rankings.

The method may also include the step of:

storing permissions rights to selectively enable the modification of the data structure and/or the content objects in the content management database means.

The method may further include the step of:

displaying at a remote terminal an administration view of the electronic page, the administration view including visually distinct representations of each content pool and content object within the electronic page.

The following description refers in more detail to the various features of the present invention. To facilitate an understanding of the invention, reference is made in the description to the accompanying drawings where the electronic content publication management system and method is illustrated in a preferred embodiment. It needs to be understood that the invention is not limited to the preferred embodiment as illustrated in the drawings.

In the drawings:

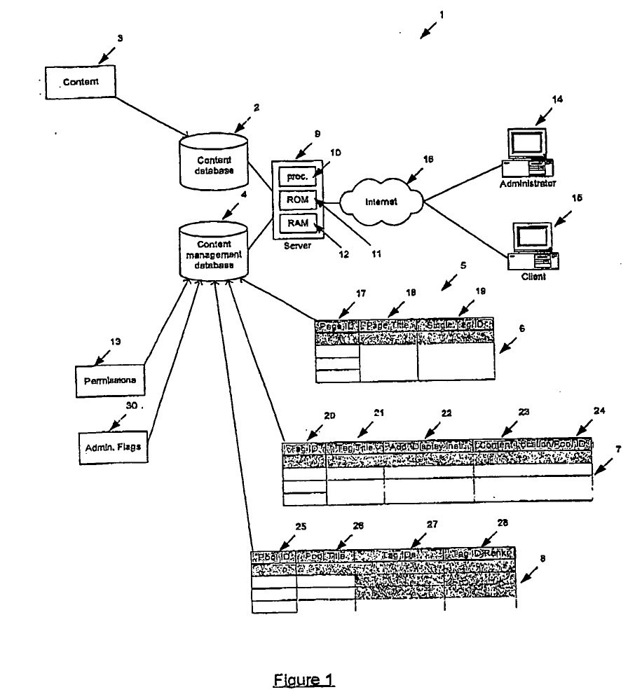

FIG. 1 is a schematic diagram illustrating one embodiment of an electronic content publication management system in accordance with the invention;

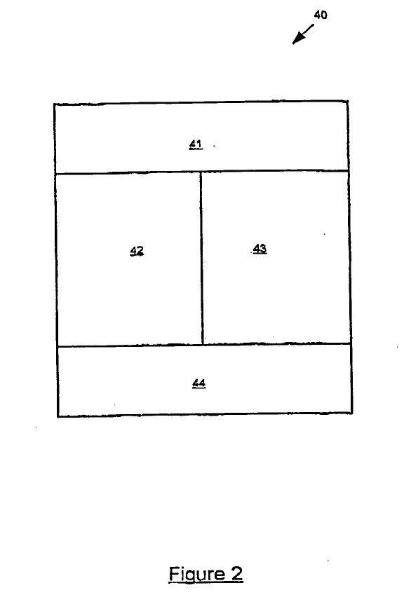

FIG. 2 is a depiction of an electronic page generated by the system of FIG. 1;

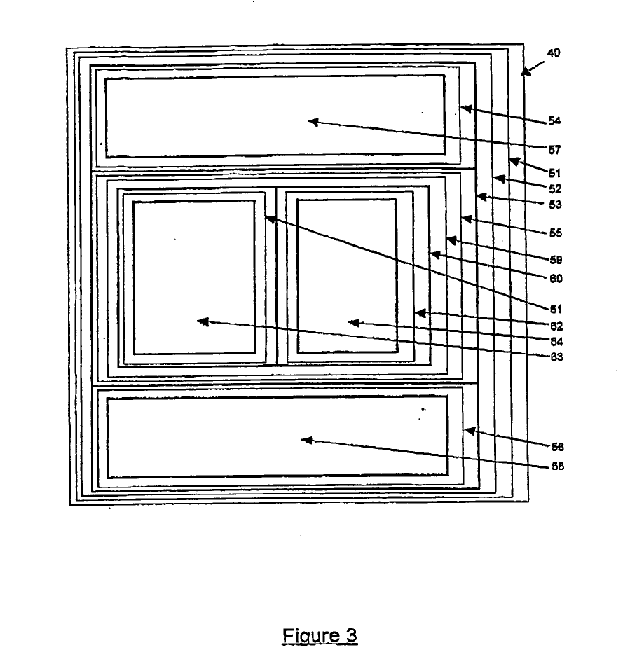

FIG. 3 is a depiction of the electronic page of FIG. 2 showing the control structure of that page;

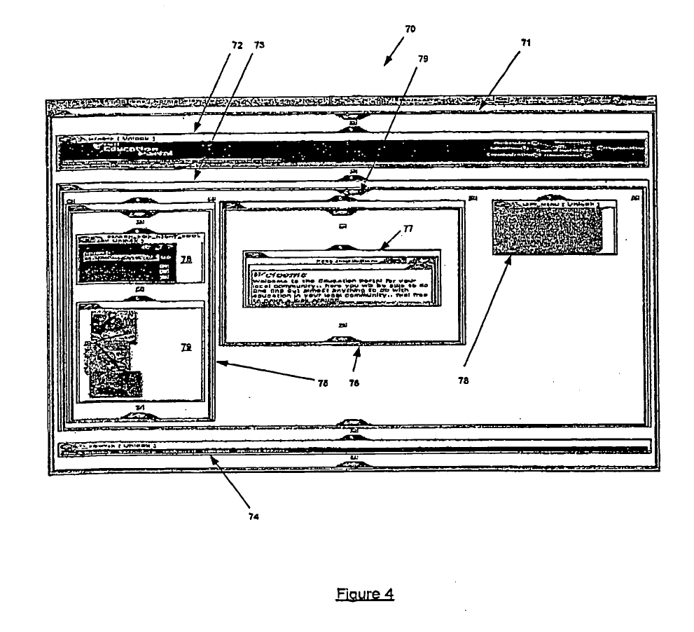

FIG. 4 is first representation of an administration view of another electronic page generated by the system of FIG. 1 highlighting a first set of control elements;

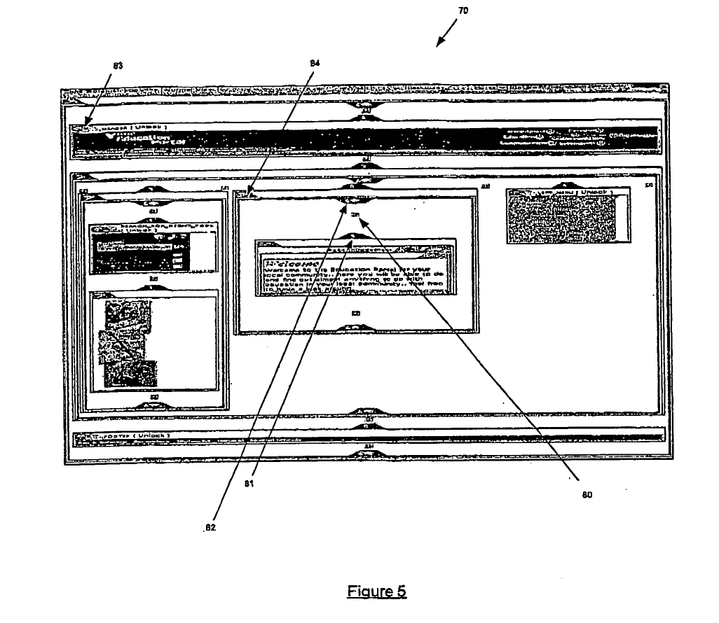

FIG. 5 is another representation of the administration view of the electronic page shown in FIG. 4 highlighting a second set of control elements;

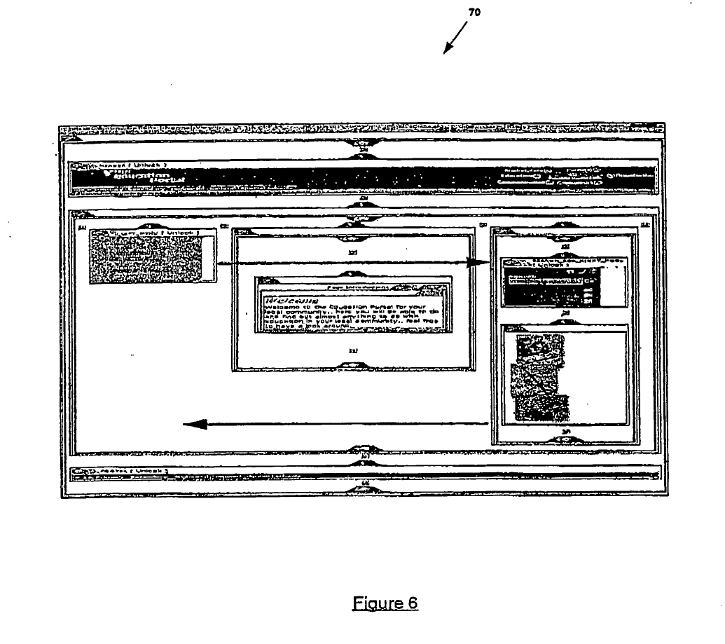

FIG. 6 is yet another representation of the administration view of the electronic page shown in FIG. 4 in which structural elements in the page have been interchanged;

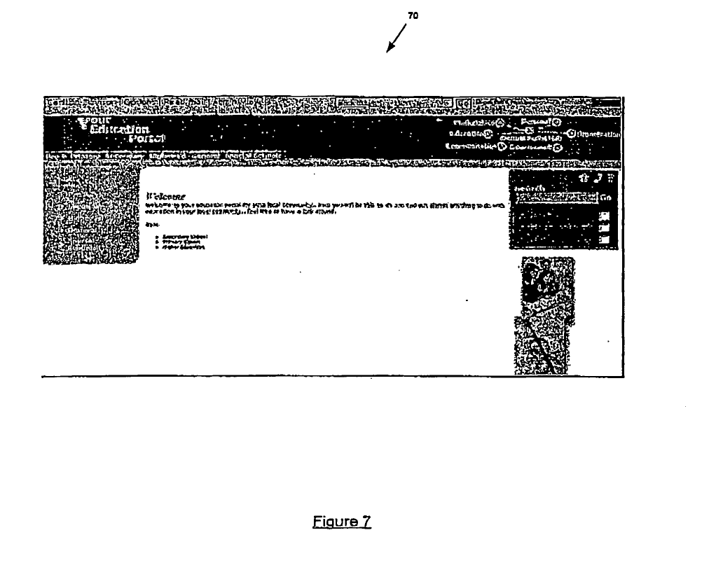

FIG. 7 is a representation of a standard view of the electronic page shown in FIG. 4 to 6; and

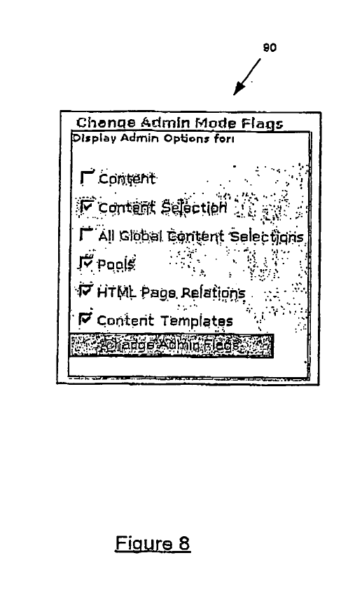

FIG. 8 is a representation of a control options display presented to administrators and other users of the system shown in FIG. 1.

Referring now to FIG. 1, there is shown generally an embodiment of an electronic content publication management system 1 in accordance with the present invention. The system 1 includes a content database 2 for storing content objects 3, including text, image and other objects that may be included within one or more web or other electronic pages of an electronically accessible site. A content management database 4 stores a data structure 5 including, in this example, data tables 6, 7 and 8. The data structure 5 identifies and interrelates structural elements within an electronic page. A server 9 includes a processing unit 10 and associated memory devices 11 and 12. A memory device 11 stores computer program instructions that cause the processor 10 to generate completed electronic pages using the stored data structure 5 and the stored content objects 3. The memory device 12 acts to temporarily store data required by the processor 10 during operation.

The content management database 4 also maintains permission rights 13 to selectively enable modification of the data structure 5 and/or the content objects 3 from a remote ministration terminal 14 or other remote client terminal 15. The administer terminal 14 and client terminal 15 are connected to the server 9 via a data network 16, such as the Internet, and Intranet or local area network (LAN) or other like network.

FIG. 2 shows an exemplary electronic page 40, and structural elements within that page, which will be used to illustrate the manner in which that page structure is created and able to be modified by the system of FIG. 1. The electronic page 40 includes a header 41, a left content area 42, a right content area 43 and a footer 44. The structural layout of the electronic page 40 is formed using a structure of nested control devices or elements, which are not ordinarily visible on the rendered electronic page. The system 1 utilises a system of pointers or tags, content pools and nested table structures to enable the creation of the electronic page 40.

The electronic page 40 can be thought of a single container into which is inserted a content pool containing an unlimited number of other containers. Each of these other containers can hold and format another content pool, which can in turn hold an unlimited number of containers. The process is able to be repeated indefinitely to create a structure with sufficient levels of nested content containers organised appropriately into content pools. The functionality provided by the computer program instructions maintained in the server 10 enables appropriate table layouts in which to wrap content containers from content groups to be defined, in order to achieve a desired page structure. With the desired page structure in place, containers within the same structure are used to create both the look and feel of the electronic page and to manage the content of that page. Each container or pool can be identified and displayed independently, enabling sub sections of a page, including columns, rows or other page elements, to be managed individually and displayed in multiple locations.

Permission rights may be assigned to administrators or other users to enable the selective creation or modification of specific content items. Accordingly, non programmers are able to add or modify page structure as well as content. The system 1 divides traditional page level of control of an electronically accessible site into many distinct levels of control, each of which can be delegated to non programmers.

The various structural control devices used by the system 1 to generate the electronic page 40 are depicted in FIG. 3. The electronic page 40 is identified by a tag 51 that contains a content pool 52. The content pool 52 can be seen to contain a table 53 comprising three cells arranged in one column of three rows. Tags 54, 55 and 56 identify each of the three table cells contained in the pool 52, thus effectively dividing the electronic page 40 into three rows. The tag 54 in the top row of the table 53 can be seen to contain a content object 57 that forms the header portion of the electronic document 40. The tag 56 in the bottom row of the table 53 can be seen to contain another content object 58 that forms the footer portion. The tag 55 in the middle row of the table 53 can be seen to contain further nested levels of structural control devices.

Specifically, the tag 55 in the middle row of the table 53 can be seen to contain a further content pool 59. The content pool 59 contains a table 60 comprising two cells, this time arranged as two columns within a same row. The two cells are identified by tags 61 and 62, respectively corresponding to the left cell and the right cell within the table 60. The tag 61 identifying the left cell in the table 60 can be seen to contain a content object 63, whilst the tag 62 in the right column of the table 60 can be seen to contain a content object 64.

The above described example is illustrative of the types control structures used in the system 1 to enable the creation and modification of the structure and content of electronic pages. Various levels of control are provided by the system 1, namely page control, tag control and content pool control. The first level of the electronic page control structure is the definition of each electronic page in an electronically accessible site. No hypertext mark up language (HTML) or other high level language is required to be coded into the electronic pages created by the system 1. Each electronic page is instead defined by data stored in the content management database 4 shown in FIG. 1, which includes:

a unique page identifier 17

a page title 18

a single tag identifier 19.

The tag associated with each electronic page defines the next level of the electronic page control structure. Once again, no HTML or high level language is encoded into the tags themselves. Each tag is defined by data stored in the content management database 4, which includes:
a unique tag identifier 20
a tag title 21
additional display instructions 22 and either:
the location 23 of a content object stored in the content database 2 (if the tag is used to display a content object), or
a single content pool identifier 24 (if the tag is used to create further nested page structure).

If the tag is used only to display a content object, the contents simply appears in place of the tag whenever the content page is displayed at a remote terminal. If, however, the tag is used to build upon the existing electronic page control structure, it effectively points to a single content pool.

The content pool pointed to by a tag defines an additional level of the electronic page control structure. Once again no HTML or other high level language is encoded into the pool itself, but rather each content pool is defined by data stored in the content management database 4, which includes:
a unique content pool identifier 25
a pool title 26
a list of one or more tag identifiers 26 and their associated tag ranking 28.

A content pool can contain any number of tags each with its own ranking within the content pool. The additional display instructions 22 can use a simple table to display items in the content pool with one tag displayed in each cell of the table. This enables non-program as to control the page layout by defining the number of columns or rows to use. For example, to divide an electronic page into 3 columns, the additional display instructions 22 may set the number of columns to 3 and corresponding coding is then automatically included by the processor 10 when the electronic page is displayed.

Tags associated with a content pool define a further level of the pages control structure. All tags have the same structure and are functionally equivalent to each other, regardless of which level of the electronic page control structure they are used in. Specifically, a tag used in an upper level of the electronic pages control structure to identify a page is the same as a tag used within a content pool in a lower level of the control structure. Moreover, any tag can point to either a content object or to a content pool. A content pool can in turn contain tags which themselves point to content pools, this pattern being able to be repeated indefinitely to define an infinitely variable nested control structure.

FIG. 4 is an example of an electronic page 70 constructed by the system 1 and served to the administrator terminal 14. The processor 10 is adapted to include visually distinct representations of each content pool and content object within the electronic page 70 for viewing and manipulation by an administrator at the administrator terminal. Accordingly, it can be seen that the electronic page 70 includes a first content pool 71 containing a table of 3 cells arranged in one column with 3 rows. These 3 cells respectively define a header 72, a body portion 73 and a footer 74. Whilst the header 72 and footer 74 each contain content objects, the body portion 73 defines a nested content pool comprising 3 cells arranged as 3 columns in 1 row. The left cell 75 defines a further nested pool including a first content object 78 and a second content object 79. The centre cell defines a further nested pool including a content object 77, whilst the right cell directly defines a content object 77. The modified format shown in FIG. 4 is an administration view presented to an administrator at the administrator terminal 14. The administration view is designed to look as much like a conventional electronic page as possible, whilst maximizing an administrator's view to manage the electronic page effectively through a point and click interface. To that end, each visually distinct representation of each content pool and content object within the electronic page 70 includes one or more control elements to enable user modification of that content pool or content object within the data structure 5.

As can be seen in FIG. 5, examples of these control elements include an add button 80, a remove button 81, and a rank button 82. The add button is used to add either a new content pool or content object to the data structure defining the electronic page 70. The remove button 82 is used to delete content pools or content objects from the electronic page 70.

The rank button 82 is used to change the order in which items appear on the electronic page 70. Each group of items that can be ranked, such as the 3 cells 75, 76 and 78 within the content pool 73, is shown in the administration view of the electronic page 70 with such a rank button. Inside the group boundary, items with a lower rank will be placed at the top and to the left. For example, to rearrange the 3 cells 75, 76 and 78, an administrator is able to click on a rank button 79 on the border immediately outside the three displayed cell to be ranked, so that there is only ever one appropriate rank button per cell. The administrator is then provided with the option of entering new rankings associated with the tag identifier defining each cell within a content pool. Once the rankings have been updated, the processor 10 causes the positions of the cells to be displayed in an altered manner as shown in FIG. 6, corresponding to the updated tag rankings.

A standard view of the electronic page 70, that is, a view of the electronic page 70 that would conventionally be served to a client without the additional visual information provided in an administration view of the electronic page, is shown in FIG. 7.

The administration view of the electronic page 70 shown in FIG. 5 also includes content selection control buttons, such as those referenced 83 and 84, to change the look and feel of the content displayed at the contact object.

To simplify the presentation of visual information to an administrator, a series of control devices may be selectively presented to or hidden from an administrator. To that end, an exemplary control options display 90 is shown in FIG. 8. Check boxes in the control options display 90 enable an administrator to toggle various administration flags 30 maintained in the content management database 4 shown in FIG. 1. For example, if the check box labelled “content” in the options display 90 is deselected, the content administration options previously described will be hidden.

Access to the fall range of administration flags are only provided to system administrators. Selected access to one or more of the administration flags may be delegated by system administrator to a number of other users according to the permission rights 13 maintained in the content management database 4. For example, users who have no permission rights to edit, create or manage content will not be presented with the option of being displayed on administration view of a particular electronic page in which the visually distinct control elements enabling that function to be performed by the system 1 are displayed.

The various permission rights 13 maintained in the content management database 4 may include the right to delegate some or all of the permission rights. Accordingly, delegation of the right to create and manage electronic page design, layout and content need not necessarily be controlled by a single system administrator, but may be delegated to one or more authorized persons who are then provided with sufficient permission rights to delegate selected rights to one or more other persons.

Finally, it is to be understood that various modifications and/or additions may be made to the electronic content publication management system and method without departing from the spirit or ambit of the invention as defined in the claims appended hereto.

1. An electronic content publication management system for publishing content to one or more electronically accessible sites, each site including at least one electronic page, the system comprising:
content database means for storing a plurality of content objects;
content management database means for storing a data structure identifying each electronic page, the layout at one or more content pools within each page and the layout of one or more content elements within each page, wherein the data structure identifies the layout of one or more nested content pools or content objects within each content pool; and
electronic page assembly means for generating one or more completed electronic pages for each site using the stored data structure and stored content objects.

2. An electronic content publication management system according to claim 1, wherein the data structure includes a plurality of tags each identifying a separate electronic page, content pool or content object.

3. An electronic content publication management system according to claim 2, wherein each tag identifies the location of one or more content objects or one or more content pools.

4. An electronic content publication management system according to claim 3, wherein at least one content pool tag identifies one or more other tags.

5. An electronic content publication management system according to claim 4, wherein the one or more other tags each include an associated ranking of that tag within an associated content pool.

6. An electronic content publication management system according to claim 5, wherein one or more tags include display instructions for use in conjunction with the tag rankings to control the layout of content objects within the electronic page.

7. An electronic content publication management system according to claim 5, wherein the electronic page assembly means is adapted to layout the content pools or contents objects identified by the one or more other tags in a table within the electronic page according to the tag rankings.

8. An electronic content publication management system according to claim 1, wherein the content management database means stores permission rights to selectively enable the modification of the data structure and/or the content objects.

9. An electronic content publication management system according to claim 8, wherein the permission rights include the right to delegate some or all of the permission rights.

10. An electronic content publication management system according to claim 1, wherein the electronic page assembly means is adapted to display at a remote terminal an administration view of the electronic page, the administration view including visually distinct representations of each content pool and content object within the electronic page.

11. An electronic content publication management system according to claim 10, wherein each visually distinct representation includes one or more control elements to enable user modification of that content pool or content object within the data structure.

12. An electronic content publication management method for publishing content to one or more electronically accessible sites, each site including at least one electronic page, the method including the steps of:
storing a plurality of content objects in content database means;
storing a data structure identifying each electronic page, the layout of one or more content pools within each page and the layout of one or more content elements within each page in content management database means, wherein the data structure identifies the layout of one or more nested content pools or content objects within each content pool; and
generating one or more completed electronic pages for each site using the stored data structure and stored content objects.

13. An electronic content publication management method according to claim 12, wherein the data structure includes a plurality of tags each identifying separate electronic page, content pool or content object.

14. An electronic content publication management method according to claim 13, wherein each tag identifies the location of one or more content objects or one or more content pools.

15. An electronic content publication management method according to claim 14, wherein at least one content pool tag identifies one or more other tags.

16. An electronic content publication management method according to claim 15, wherein the one or more other tags each include an associated ranking of that tag within an associated content pool.

17. An electronic content publication management method according to claim 16, wherein one or more tags include display instructions for use in conjunction with the tag rankings to control the layout of content objects within the electronic page.

18. An electronic content publication management method according to claim 16, and further including the step of:
laying out the content pools or contents objects identified by the one or more other tags in a table within the electronic page according to the tag rankings.

19. An electronic content publication management method according to claim 12, and further including the step of:
storing permission rights to selectively enable the modification of the data structure and/or the content objects in the content management database means.

20. An electronic content publication management method according to claim 19, wherein the permission rights include the right to delegate some or all of the permission rights.

21. An electronic content publication management method according to claim 12, and further including the step of:
displaying at a remote terminal an administration view of the electronic page, the administration view including visually distinct representations of each content pool and content object within the electronic page.

22. An electronic content publication management method according to claim 21, wherein each visually distinct representation includes one or more control elements to enable user modification of that content pool or content object within the data structure.

23. An electronic content publication management system according to claim claim 6, wherein the electronic page assembly means is adapted to layout the content pools or contents objects identified by the one or more other tags in a table within the electronic page according to the tag rankings.

24. An electronic content publication management method according to claim 17, and further including the step of:
laying out the content pools or contents objects identified by the one or more other tags in a table within the electronic page according to the tag rankings.
